(19) United States
(12) Patent Application Publication
(10) Pub. No.: US 2011/0098880 A1
(43) Pub. Date: Apr. 28, 2011

(54) REDUCED TRANSMISSION OF VEHICLE OPERATING DATA

(76) Inventors: Otman A. Basir, Waterloo (CA); William Ben Miners, Guelph (CA); Hani Hawari, Waterloo (CA); Jason Toonstra, Elmira (CA)

(21) Appl. No.: 12/911,000

(22) Filed: Oct. 25, 2010

Related U.S. Application Data
(60) Provisional application No. 61/254,496, filed on Oct. 23, 2009.
(60) Provisional application No. 61/324,198, filed on Apr. 14, 2010.

(51) Int. Cl. G06F 19/00

(52) U.S. Cl. 701/33

(57) ABSTRACT

An in vehicle appliance gathers data from various sensors mounted within the vehicle, stores that data and generates summaries of that data for transmission through a wireless network. The data summaries reduce the length of the transmission over a wireless network while providing sufficient data to characterize vehicle operations without excessive transmission length, cost and use of available bandwidth.

### CROSS REFERENCE TO RELATED APPLICATION

This application claims priority to U.S. Provisional Application Nos. 61/254,496 filed on Oct. 23, 2009 and U.S. Provisional Application No. 61/324,198 filed on Apr. 14, 2010.

### BACKGROUND

This disclosure generally relates to system and method of communicating information over a wireless network indicative of vehicle operation to a remote location. More particularly, this disclosure relates to a method of reducing usage of a wireless network during communication of information indicative of vehicle operation to a remote location.

Data indicative of vehicle operation is gathered for a many different purposes, such as for example, determining an insurance premium, monitoring vehicle performance and tracking vehicle location. Data indicative of vehicle operation may included location, speed, and time within a defined zone or at a certain speed. Moreover, data indicative of overall vehicle operation such as engine temperature, speed, temperature and other measured parameters that indicates a level of vehicle performance and when maintenance may be required. As appreciated, the amount of gathered data can become quite large and difficult to manipulate efficiently. Moreover, in instances where such operation data is transmitted over a wireless link to a remote location, the volume of data can result in significant cost and data processing burdens that can discourage implementation of a beneficial monitoring system.

### SUMMARY

A disclosed in vehicle appliance gathers data from various sensors mounted within the vehicle, stores that data and generates summaries of that data for transmission through a wireless network. The summaries can be utilized for tracking and determining various parameters such as insurance premiums for the motor vehicle, tracking data utilized to determine proper operation of the vehicle and other information that may provide value such as alerting a maintenance depot or service center when a specific vehicle is in need of such maintenance. Transmission of large amounts of data over a wireless network can incur substantial costs. The example in vehicle appliance processes and manipulates the gathered data to generate summaries for transmission over the wireless network to provide sufficient data to characterize vehicle operations without excessive transmission length, cost and use of available bandwidth.

These and other features disclosed herein can be best understood from the following specification and drawings, the following of which is a brief description.

### BRIEF DESCRIPTION OF THE DRAWINGS

FIG. 1 is a schematic view of an example system for gathering data indicative of vehicle operation.

FIG. 2 a schematic view of the example appliance and ranges for summarizing data.

### DETAILED DESCRIPTION

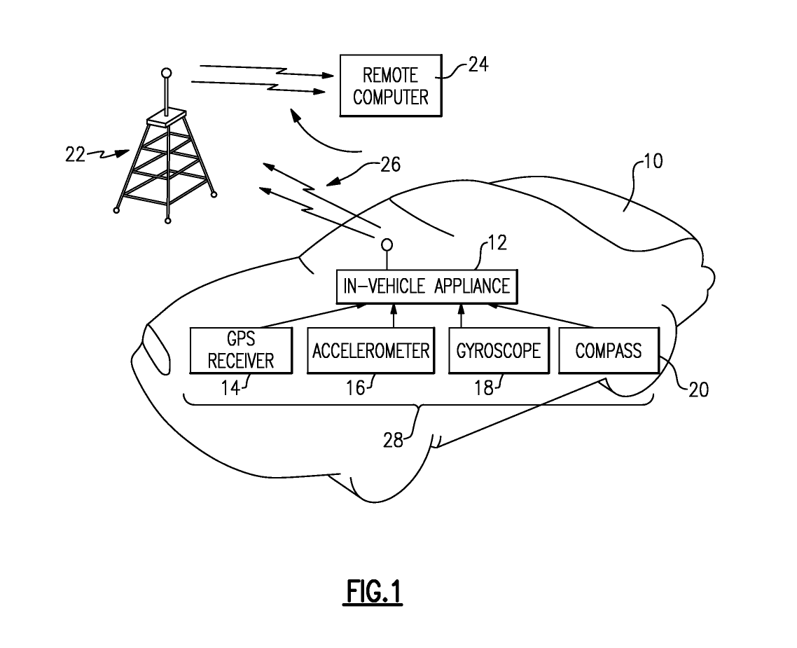

Referring to FIG. 1, a motor vehicle 10 includes a plurality of data gathering devices 28 that communicate information to an appliance 12 installed within the vehicle 10. The example data gathering devices 28 include a global positioning satellite (GPS) receiver 14, an accelerometer 16, a gyroscope 18 and an electronic compass 20. As appreciated, other data monitoring systems could be utilized within the contemplation of this invention. Such other data gathering devices that could also communicate with the appliance 12 include data collected from a global navigation satellite system receiver that would provide location, time, speed and other information indicative of vehicle operations. Data may also be collected from an onboard diagnostic port (OBD) that provides data indicative of vehicle engine operating parameters such as engine speed, temperature and other information that is related to mechanical operation of the vehicle. Moreover, any other data that is available to the vehicle could also be communicated to the appliance 12 for gathering and compilation of the operation summaries of interest in categorizing the overall operation of the vehicle.

The in vehicle appliance 12 gathers data from the various sensors 38 mounted within the vehicle 10 and stores that data. As appreciated, the amount of data compiled can result in very large and extensive amounts of specific data related to all aspects of vehicle operation. The in vehicle appliance 12 summarizes and transmits this data as a transmission signal 26 through a wireless network schematically indicated at 22 to a remotely located computer 24. The remotely located computer 24 utilizes the received data to categorize vehicle operating conditions in order to determine or track vehicle use. This data can be utilized for tracking and determining various parameters such as insurance premiums for the motor vehicle, tracking data utilized to determine proper operation of the vehicle and other information that may provide value such as alerting a maintenance depot or service center when a specific vehicle is in need of such maintenance.

The massive amounts of data gathered by the vehicle sensors 28 cannot be efficiently transmitted over the wireless network and could result in substantially large amounts of data resulting in excessive signal and communication costs. The excessive costs resulting in transmission of such large amounts of data over the wireless network 22 could inhibit the application and acceptance of such data acquisition systems. Accordingly, the example in vehicle appliance 12 process and manipulates the gathered data to generate a summary for transmission over the wireless network 22 that provides sufficient data to characterize vehicle operations without excessive transmission length or use of available bandwidth.

The example vehicle appliance 12 is mounted within the vehicle 12 and performs operations within the vehicle separate from the transmissions that are sent to the remotely located computer 24. The operations that are performed within the vehicle 10 by the appliance 12 conserve bandwidth and result in the formulation of a substantially reduced transmission length that utilizes much less bandwidth and therefore reduces overall communication costs.

The example appliance 12 receives information from each of the in vehicle sensors 28 on an ongoing basis. This received data can be stored within the vehicle appliance 12 as desired or it may be collected at specific intervals that are defined to provide the desired amount of information. No matter how the data is collected from the various sensors that data is extensive in view of the available and desired transmission lengths required to report the information to the remote relocated computer 24.

Accordingly, the accumulated data and information stored within the appliance 12 is processed to generate a summary that remains indicative of the underlying data gathered and stored, while also being capable of transmission within a reasonable and desirable bandwidth and length ranges. Accordingly, the appliance 12 collects data from the various vehicle sensors 28 and summarizes this data into specific categories and ranges that are then utilized to formulate a transmission that utilizes a much smaller and manageable bandwidth and duration.

The example summaries of the accumulated data are compiled according to defined and desired characteristics. Specific characteristics can be utilized to define the various parameters. These characteristics may be predefined in view of the information and how the information is going to be utilized once received by the remotely located computer 24. The information can also be summarized based on both current and historical trends in the gathered data. In other words, based on historical use of the vehicle operation reflected by the accumulated data, specific ranges could be formulated to reflect normal operation and other operations that may fall outside the historic normal vehicle operating parameters. Such ranges could include time within a specific location or time at which the vehicle is operated at a given speed. These parameters could be summarized into normal operating conditions and also in contrast conditions that fall outside these normal operating parameters such that a clear picture of any unique vehicle operations could be illustrated in the data summaries.

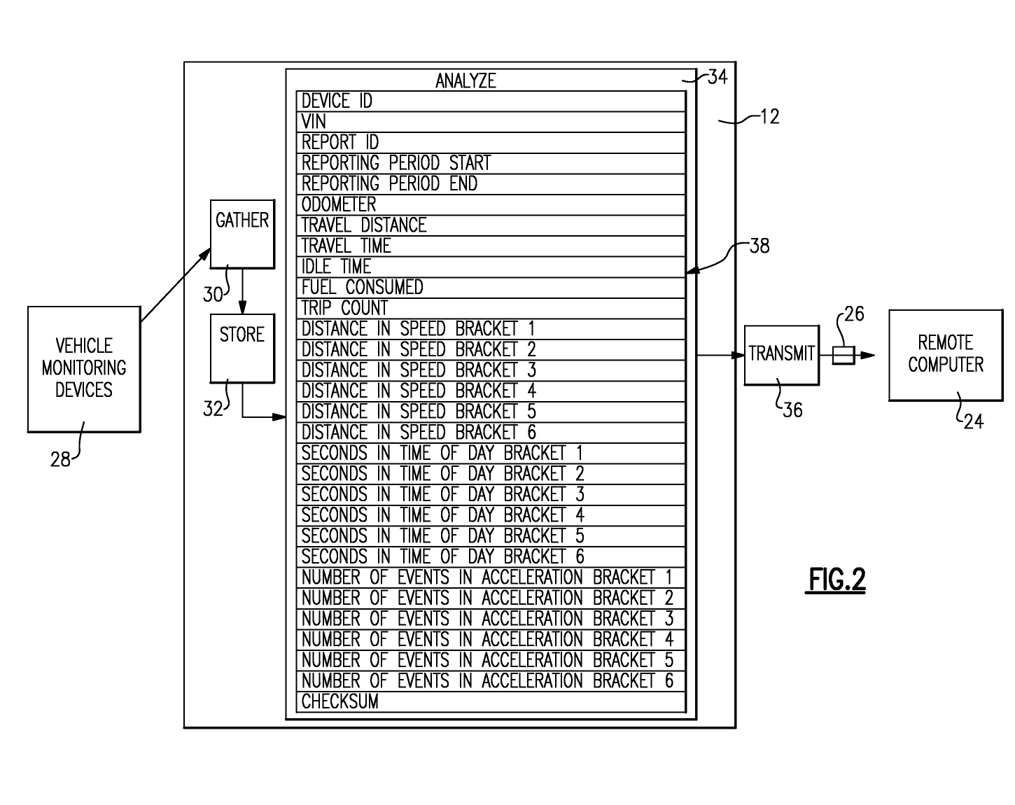

Referring to FIG. 2, in another example the gathered data could be summarized as an incremental count as to each time that a specific vehicle parameter is encountered in a specified data range. For example, each time the vehicle is operated within a speed bracket of between 20-50 mph, that operation period can be reflected as a single occurrence instead of being reflected in multiple the instantaneous velocity data points over a given time range that would result in a large amount of data. In this example the entire operating period is represented by a single increment for the vehicle being operated in that defined speed range. In other words, for example, any time the motor vehicle 10 is operated within the range of between 20-50 mph for a length of time exceeding a predefined time, a summary is incremented by one. The resulting summaries will then include a number indicating the amount of time in which a vehicle is operated within each of the specific ranges.

FIG. 2 is a schematic representation of the appliance 12 that includes a first portion 30 that gathers data from the various vehicle monitoring devices 28. The example appliance 12 also includes a storage portion 32 that stores data received from the vehicle monitoring devices. The storage could be any memory or other data gathering device or appliance as is known to a worker skilled in the art. This data is utilized by a third portion 34 that analyzes the data and summarizes that data into a more compact form that is suitable for the short transmission lengths and reduce bandwidth transmission signals that are desired and provided by the example appliance 12. The appliance 12 further includes a transmission module 36 that formulates the summarized data for transmission as the transmission indicated by 26 that is communicated over the wireless network 22 and to a remotely located computer 24.

The third portion 34 provides an analysis and summation of the various data gathered by the vehicle monitoring devices 28. This analysis and summation can be obtained in various manners to provide reduced transmission size and length that corresponds with reduced costs while still maintaining and providing adequate levels of information needed to make and record desired operating parameters of the motor vehicle 10. These various brackets as illustrated in FIG. 2 can include many different parameters such as distance in a speed bracket, time of day within each bracket, the number events in which acceleration exceeds a given value along with other events such as a summation of the entire time period or distance traveled in given reporting time period.

In this example, various specific ranges indicated at 38 are utilized and include distance and speed along with an incremented number of events in one of the acceleration brackets. Each of the brackets could include speeds within specific ranges such as for example, from 0-20 mph; the distance in another speed bracket could include speeds from 20-50 mph, and further with the later speed brackets indicating higher speeds of the vehicle of reduced range size. As appreciated, the specific ranges could be tailored in view of historical operations of the vehicle such that vehicles that are operated in lower speed ranges could have additional brackets to further characterize operation in those lower speed ranges.

The brackets could also include time spent in each of the different speed brackets, a count of acceleration and deceleration events that occur within each of the different brackets along with the distance driven and time of day that the vehicle is operated within those brackets. Moreover, the time driven in different time of day brackets could also be included and indicated with reference to the time and distance driven within specific geographic zones or regions that could be identified by postal codes or other municipal divisions such as city, county and state.

The data transmission interval is also configurable and can be sent based on the desired need for information by the remote computer 24. In this example a transmission is sent periodically such as everyday or on a specific day of the month. A specific period in which a transmission is made by the appliance 12 can be set to occur based on a time interval or may also be set to occur based on a triggering event. In one example, a triggering event may be defined as when a certain speed has been reached or acceleration has been reached that is indicative of a certain vehicle operating condition of interest. Moreover, some vehicle acceleration or deceleration events could also be indicative of a crash or other vehicle failure that would be of interest and therefore trigger transmission of the analyzed and stored summary of data.

The appliance uses an adaptive coding scheme to minimize the number of bits and therefore the length of the transmission 26 that is sent from the appliance 12. In this example the appliance generates transmissions that are set to be only four bits long that are used for each of the speed brackets instead of two digits which takes 16 bits. The same transmission configuration could apply for each of the brackets such that distances and time are not coded in binary and not ASCII code to provide a reduced transmission length. The transmission coding could also utilize a compression scheme that compress the summarized data and further reduce the amount of bandwidth required for each of the transmissions 26.

Each of the transmissions may also be encrypted to prevent unauthorized opening or review of the forwarded data. As appreciated, the data is transmitted over a wireless network 22 and is therefore susceptible to interception and review by those not intended to receive the transmission 26.

The content of the summaries are defined to provide desired levels of precision. As is appreciated, a reduction in the number of data points has an impact on the level of precision or desired accuracy of a summarized data value. Moreover, not all of the data values are comparable in importance such that some information is utilized more frequently, or relied to a larger degree than other data values. Furthermore, the level of importance of each data value can fluctuate with operation of the vehicle depending on many factors. For example the time or day that a vehicle is operated within a specific location may become of greater interest in the evening hours as compared to operation during the day. Accordingly, some data values should be reported with higher precision than others. Therefore, the disclosed appliance 12 provides for the modification of how the various summaries 38 are generated and transmitted.

The example appliance 12 includes the third portion that analyzes data into a plurality of defined summary values. As discussed above, the defined summary values can be determined according to different desired criteria. This method includes the further criteria of desired precision that is included and factored into the determination of each summary value.

In this example not all the summary values are generated to the same level of precision. The level of precision can be modified by using more or less data points to create the summary value. Moreover, the level of precision can be further modified using known statistical methods. Once the level of desired precision is determined, each of the summaries is then utilized to create the transmission.

The amount of space or number of bits of the transmission 26 that are consumed by each summary value may be different depending on the desired level of precision. Therefore, some of the data values that comprise the transmission may consume more or less of the overall transmission length.

The precision and timing of each of the summary values can also be adjusted and optimized in view of changing factors and priorities in the operation of the motor vehicle. The precision with which each of the summaries or portions of the transmission are formulated can be adapted to changing conditions. The adaptation may be fully automated and executed by the appliance 12, or can be semi-automatic using historical data and pre-specified constraints as adaptation boundaries. The adaptation boundaries could be configured to accommodate conditions external to vehicle operation such as communication costs in view of the value provided by a desired precision level. The precision adaptation of each of the individual summary values provides for the preservation of as much data as possible while limiting required storage space, transmission length and wireless network usage costs.

Accordingly, the example appliance gathers data and organizes that data into summaries that provide a control or are utilized to generate a transmission 26 of substantially reduced length and duration that not only makes each transmission shorter and more efficient but also maintains that desired character of data reflective of vehicle operation.

Although an example embodiment has been disclosed, a worker of ordinary skill in this art would recognize that certain modifications would come within the scope of this disclosure. For that reason, the following claims should be studied to determine the scope and content of this invention.

What is claimed is:

1. A method of gathering and transmitting vehicle performance information comprising:
gathering information indicative of vehicle operation with an appliance installed within the vehicle;
analyzing the gathered information indicative of vehicle operation with the appliance to define a plurality of parameters that characterize vehicle operation;
transforming the gathered information within each of the defined plurality of parameters into a summary of values indicative of vehicle operation with the appliance; and
transmitting the summary of values with the appliance over a wireless network to a remote processing center.

2. The method as recited in claim 1, wherein the summary of values are defined by the appliance based on defined vehicle operating trends detected in the information gathered indicative of vehicle operation.

3. The method as recited in claim 1, wherein the summary of values indicative of vehicle information comprises an incremental count of a parameter occurrence over a defined data collection period.

4. The method as recited in claim 1, wherein the summary of values indicative of vehicle operation comprises a summation count of a certain parameter over a defined data collection period.

5. The method as recited in claim 1, wherein the summary of values indicative of vehicle operation comprises a plurality of subgroups representing a defined range of vehicle operating parameters and the data indicative of vehicle operation are combined into a single value within each of the defined ranges.

6. The method as recited in claim 1, wherein the summary of values indicative of vehicle operation are coded in binary for reducing a length of a wireless transmission sent by the appliance to the remote processing center.

7. The method as recited in claim 1, wherein each of the summary values is formed at a desired precision level responsive to a defined importance of a particular one of the summary values.

8. The method as recited in claim 7, wherein the desired precision level is modified in response to a desired triggering event.

9. The method as recited in claim 8, wherein the desired precision level is adaptive to current vehicle operations such that a precision level of each of the summary values is adapted responsive to defined vehicle operating characteristic.

10. The method as recited in claim 9, wherein the desired precision level is adaptive to a parameter external and separate from vehicle operations.

11. The method as recited in claim 1, including transmitting the summary of values over the wireless network in response to a defined triggering event.

12. The method as recite in claim 11, wherein the triggering event comprises a vehicle operating parameter detected within a defined range.

13. The method as recited in claim 11, wherein the triggering event comprises a summary of values indicative of vehicle operation being within a defined range.

14. An appliance for monitoring and communicating vehicle operations comprising:
a first portion communicating with data gathering by monitoring devices that provide data indicative of vehicle operating conditions;
a second portion for storing the data gathered from the monitoring devices;
a third portion for analyzing the data gathered and organizing the data into one of a plurality of defined data ranges and summarizing the gathered data as a defined set of values; and
a fourth portion that transmits the defined set of values over a wireless network to a remote processing location, wherein the defined set of values form a wireless transmission length much less than transmission length comprising individual data points of the data gathered from the monitoring devices.

15. The appliance as recited in claim 14, wherein the third portion summarizes the gathered data into a plurality summations of information indicative of vehicle operations.

16. The appliance as recited in claim 14, wherein a summary of the data within each of the defined set of values comprises an incremental count of a vehicle operating parameter falling within one of a plurality of defined operating ranges.

17. The appliance as recited in claim 14, wherein the defined set of values is determined based on current and historical data indicative of vehicle operating conditions.

18. The appliance as recited in claim 14, wherein the appliance transmits the summarized set of values responsive to a defined triggering event.
